(19) United States
(12) Patent Application Publication
(10) Pub. No.: US 2021/0258758 A1
(43) Pub. Date: Aug. 19, 2021

(54) Emergency Response Communication System

(71) Applicant: Edward McGovern, Miami, FL (US)

(72) Inventor: Edward McGovern, Miami, FL (US)

(21) Appl. No.: 17/178,962

(22) Filed: Feb. 18, 2021

Related U.S. Application Data
(60) Provisional application No. 62/977,855, filed on Feb. 18, 2020.

(51) Int. Cl. H04W 4/90; H04W 4/021; H04W 4/024; H04W 4/029; H04W 4/20

(52) U.S. Cl. CPC H04W 4/90; H04W 4/021; H04W 4/20; H04W 4/029; H04W 4/024

(57) ABSTRACT

A method of managing communication during an emergency situation for a selected group of people includes transmitting, through a mobile application, notification of the emergency situation to law enforcement; utilizing a processor to determine location information of the emergency situation and setting up a Radius around the location; transmitting the location information to law enforcement; receiving, from a database of members, a location of a via a real time visual assisted communication within the radius; and receiving directions to the safe place.

### CROSS REFERENCE TO RELATED APPLICATIONS

This application claims priority to U.S. Provisional Application No. 62/977,855 filed Feb. 18, 2020, the entire disclosure of which is hereby incorporated by reference for all proper purposes.

### TECHNICAL FIELD

This invention relates generally to a communication system between emergency responders for a selected group of people.

### SUMMARY OF THE INVENTION

A method of managing communication during an emergency situation for a selected group of people includes transmitting, through a mobile application, notification of the emergency situation to law enforcement; utilizing a processor to determine location information of the emergency situation and setting up a Radius around the location; transmitting the location information to law enforcement; receiving, from a database of members, a location of a via a real time visual assisted communication within the radius; and receiving directions to the safe place.

### BACKGROUND

For years, the venue of First Responder Communication has had little drastic change, especially in the Law Enforcement space. Two-way radio communications have been the staple for Police, since migrating from call boxes on street corners. A majority of improvements within the past 20 years have been confined to improving the quality of this single system, and new technology created has been designed to support current radio systems. During this same time, there has been little convergence of technological advances from other platforms that would complement First Responder communications, exclusive of VHS/Radio communications. Even Computer-Assisted Dispatch (CAD), designed in part to reduce radio traffic and provide alternative information sharing, has been limited in its implementation and quality, especially for smaller Agencies with limited resources.

Communication technology in this domain has lagged behind the developments in the private sector technology. Mainly rooted in repetitive training and recycled mindsets, First Responder advancements have been hampered by a lack of creativeness, instead relying on entrenched mindsets that pass on processes for generations of Officers and staff.

The applicant is committed to increasing Public Safety. Our belief is that Public Safety starts at the local level, expanding outward to State and Federal partners. Since the average size of a Police Department in the United States is less than 50 sworn officers, the applicant is resolute in our ability to be both transformative and compatible. All of our technology is designed with the ability to integrate with small departments while retaining continuity through expansion into large organizations. This breaks the typical model of most First Responder technology advancements, which is usually derived from necessity for large departments or initiatives, only to be incompatible with small-force agencies.

Lateral Thinking is the applicant's primary objective to revolutionize First Responder Communications. We are determined to break through the confines restricting traditional networks. Our goals are focused toward complete transformation of Emergency Services communications utilizing wireless network technology and mobile application platforms. It is our belief and our experience that the keys to true advancement are commanded in this space, and the generations of future First Responders will already be completely immersed and acclimated to this technology through use in the private sector, social media, and recreation.

Advanced Technology Integration is the focal point of the applicant's mission and proposed partnership with cell providers. The optimal requirements for seamless integration into the First Responder technology space is creating and promoting applications the run on one platform with equivalent measures and processes, so that each application's features are congruent and facilitate training and retention.

Trend Development is essential for rapid expansion into the First Responder communications space. Trend Development requires three groups to be equal stakeholders in the progression into this tech area: Wireless Telecommunications Carrier(s), Emergency Services, and the Service Recipients. Applicant's first application, Critical Event Response Applications (CERA) -Schools, identifies Emergency Services as the local First Responders, and the Service Recipients, such as Teachers. The recipients receive the increase in safety and their vulnerability is greatly mitigated. Therefore, Service Recipients become the initiators of promotion and influence First Responder buy-in. Once Emergency Services implements the First Responder portion of Critical Event Response Applications (CERA), all future apps will run from the same platform, providing an invariable anchor that creates a seamless expansion of services.

There is an inability to manage critical communications as officers respond at different intervals, dispatchers have to repeat the same information multiple times. This clogs radio channels and reduces transmission capabilities. If the identity of a suspect is confirmed, Police have no way to even transmit a simple photograph to officers from other jurisdictions. With the application software, these weaknesses are eliminated. The application software of the present disclosure allows for teachers to send critical information to the Commanders. Further, Commanders can upload suspect information and photos to the application software, allowing any responding officer to access this critical data without using the radio.

### BRIEF DESCRIPTION OF THE DRAWINGS

The present disclosure will become more readily apparent from the specific description accompanied by the following drawings, in which:

FIG. 1 is a schematic of a sample a start screen in the application software as described in the present disclosure;

FIG. 2 is a schematic of a one embodiment of a safe space mapping screen in the application software described in the present disclosure; and

FIG. 3 is a schematic of a one embodiment of a recording screen in the application software described in the present disclosure.

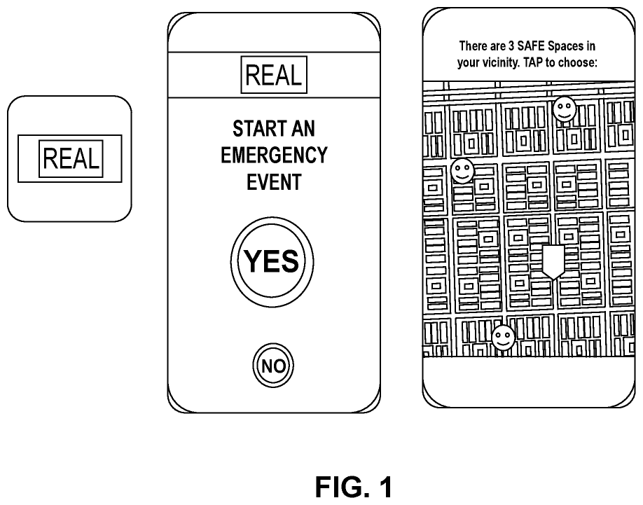

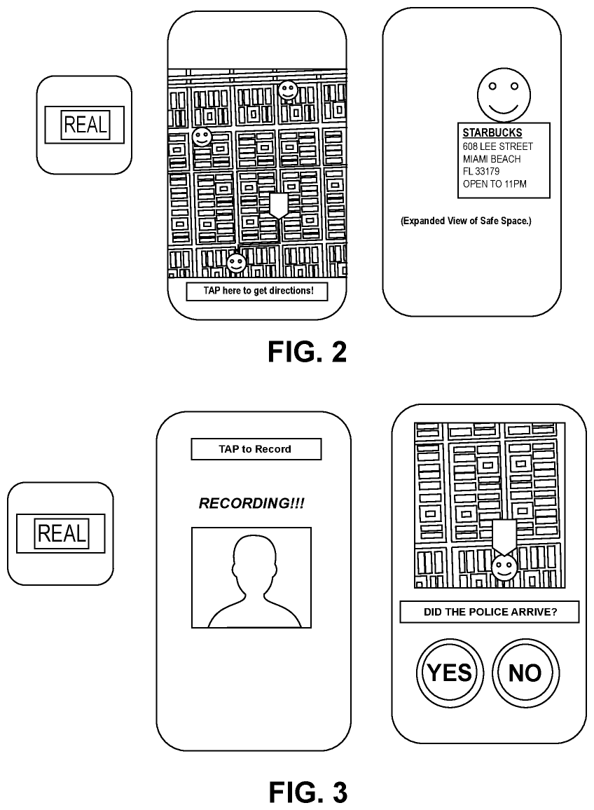

### DETAILED DESCRIPTION

In another embodiment, the present system can be used exclusively by members of selected group of people that may be subject to hate crimes. For example, the selected group of people may be selected based on race, religion, disability, sexual orientation, ethnicity, gender, and gender identity.

In some embodiments, the application software is direct to members of the lesbian, gay, bisexual, transgender and queer community (LGBTQ). Project REAL (RAPID. EMERGENCY. ASSISTANCE. LGBTQ+) is mobile application software that allows users to obtain immediate assistance when they feel threatened with imminent physical harm due to their LGBTQ status. From bullying to assault, citizens who identify as LGBTQ face a myriad of hate crimes and physical violence against them. The application software is designed to help protect its members. This system can identify and promote private businesses and government locations that pledge to be LGBTQ safe spaces and/or safe zones through existing campaigns. These locations, along with the open operating hours, will be recorded into an application software database. Qualified members of the designated LGBTQ partner organizations will download the application software to their mobile device. If users are faced with situations where they feel threatened with imminent physical harm, they will access the application software.

The application software allows users to call 911 through the application software and provides users and responders with a visual assisted communication showing with their current address, location and zip code to report to police. This same information will also be transmitted via TEXT to 911 (where available). Additionally, the application software will notify the user of the nearest open private business or government safe space location within a preset radius of the user. The application software will provide directions to the location. The user can then respond to the location to await law enforcement response. During the incident, the application software commences audio/video recording from the user's phone, which is immediately stored on the application software database if needed for criminal prosecution in a hate crime. In some embodiments, the audio and video may be certified for use in prosecution of a crime.

It is to be understood that the above-mentioned figures are only illustrative of the application of the principles of the present disclosure. Numerous modifications or alternative arrangements may be devised by those skilled in the art without departing from the spirit and scope of the present disclosure. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of managing communication during an emergency situation for a selected group of people comprising:
transmitting, through a mobile application, notification of the emergency situation to law enforcement;
utilizing a processor to determine location information of the emergency situation and setting up a radius around the location;
transmitting the location information to law enforcement;
receiving, from a database of members, a location of a safe place within the radius via a real time visual assisted communication; and
receiving directions to the safe place.

2. The method of claim 1, further comprising receiving dynamic real time location of user in the emergency situation.

3. The method of claim 1, further comprising activating the audio and video of the mobile device.

4. The method of claim 3, further comprising saving the audio and video on the mobile device.

5. The method of claim 4, further comprising certifying the content of the audio and video for use in prosecution of a crime.

6. The method of claim 1, wherein the database of members includes businesses, residential homes, government offices or places of worship.

7. The method of claim 1, wherein the selected group of people is selected from the group consisting of race, religion, disability, sexual orientation, ethnicity, gender, and gender identity.

8. The method of claim 1, wherein the visual assisted communication includes a map obtained from the database of the location.

10. A computer implemented method (CIM) comprising:
receiving a notification of an emergency situation;
responsive to the notification, determining a location of the emergency situation and calculating a radius around the location;
transmitting the location information to law enforcement;
trasmitting, from a database of members, a location of a safe place within the radius via a real time visual assisted communication; and
receiving directions to the safe place.
